(19) United States
(12) Patent Application Publication
(10) Pub. No.: US 2007/0114864 A1
(43) Pub. Date: May 24, 2007

(54) Motor with position-adjustable rotor

(75) Inventor: Sung Gon Son, Seoul (KR)

Correspondence Address: BACON & THOMAS, PLLC, 625 SLATERS LANE, FOURTH FLOOR, ALEXANDRIA, VA, 22314, US

(73) Assignee: DAEWOOD ELECTRONICS CORPORATION, Seoul (KR)

(21) Appl. No.: 11/603,002

(22) Filed: Nov. 22, 2006

(30) Foreign Application Priority Data
Nov. 23, 2005 (KR) 10-2005-0112292

(51) Int. Cl. H02K 5/16; H02K 1/22

(52) U.S. Cl. 310/90; 310/261

(57) ABSTRACT

A motor with a position-adjustable rotor, wherein a rotational shaft of the motor is rotatably supported by a holder assembly, includes a rotor of which the rotational shaft is fixed in a central portion. The rotor has a position adjusting indentation around the rotational shaft, and is formed by pressing soft magnetic powder. Further, the motor includes a position adjusting bushing, inserted into the rotational shaft to be positioned between the rotor and the holder assembly. The position adjusting bushing has an insertion unit inserted into the position adjusting indentation and a locking unit supported at an exterior side of the position adjusting indentation, wherein the insertion unit and the locking unit have different diameters or widths. In the motor, a gap between the rotor and the holder assembly is adjusted by changing a direction in which the position adjusting bushing is inserted into the rotational shaft.

### FIELD OF THE INVENTION

The present invention relates to a motor with a position-adjustable rotor, and more particularly, to a motor with a position-adjustable rotor capable of adjusting a gap between the rotor and a holder assembly, making ease of the gap adjustment, and thus implementing the same rotor to various motors with different specifications and structures.

### BACKGROUND OF THE INVENTION

In general, a motor is a device that converts electrical energy into mechanical energy to provide a rotational force. Motors are being widely applied to various industrial fields including electric home appliances and industrial machines. For instance, motors can be applied to compressors, which are installed inside cooling appliances such as air conditioners and refrigerators to restore a refrigerant to a liquid, washing machines, vacuum cleaners, optical disk players, and hard disk drivers of computers.

A conventional motor will be described with reference to FIG. 1 hereinafter.

FIG. 1 illustrates a sectional view of main parts of a conventional motor 10. The conventional motor 10 is an oilless type motor. In the conventional motor 10, holder assemblies 11 are attached individually to a casing (not shown) on both upper and lower sides. Although not illustrated, a stator is affixed to the inside of the casing. A rotor 12 is inserted into the stator (not shown) to be rotatable by having a gap inside the stator (not shown). A rotational shaft 13 passes through a central region of the rotor 12 and is affixed thereto. The rotational shaft 13 is inserted into the holder assemblies 11 to be rotatable by means of the oilless bearings 11e.

The holder assemblies 11 include bearing installation units 11a in a central region of the holder assemblies 11, and the oilless bearings 11e elastically supported by respective plate springs 11b are installed on the respective bearing installation units 11a. Each of the bearing covers 11c is attached to an exterior portion of each of the bearing installation units 11a and shields an inflow of foreign materials. The plate springs 11b are firmly fixed by the respective bearing covers 11c. Spaces that permawicks 11d having oil fill individually are formed around the oilless bearings 11e.

In the conventional motor 10, the rotor 12 and each of the holder assemblies 11 are spaced apart from each other by having a gap therebetween to optimize an electron induction event between the rotor 12 and the stator (not shown) and make the rotor 12 rotate smoothly.

However, when the specification or structure of the conventional motor 10 is changed, it may be difficult to maintain an intended gap between the rotor 12 and each of the holder assemblies 11, and the gap therebetween may not be changed. Therefore, when the specification or structure of the conventional motor 10, or the gap between the rotor 12 and each of the holder assemblies 11 is changed, another rotor with the different height often needs to be manufactured, and simultaneously, manufacturing costs may increase.

### SUMMARY OF THE INVENTION

It is, therefore, an object of the present invention to provide a motor with a position-adjustable rotor capable of adjusting a gap between the rotor and a holder assembly, making ease of the gap adjustment, and thus implementing substantially the same rotor to various motors having different specifications or structures so as to reduce manufacturing costs.

In accordance with a preferred embodiment of the present invention, there is provided a motor with a position-adjustable rotor, wherein a rotational shaft is supported to be rotatable by holder assemblies, the motor including rotor to which the rotational shaft is affixed in a central region, including position adjusting indentations around the rotational shaft, and formed by pressing soft magnetic powder, and position adjusting bushings each inserted into the rotational shaft to be positioned between the rotor and the corresponding holder assembly and including an insertion unit inserted into the corresponding position adjusting indentation and a locking unit supported at the exterior side of the corresponding position adjusting indentation by having different diameters or widths on both sides of the position adjusting bushing, wherein gaps between the rotor and each of the holder assemblies can be adjusted by changing a direction that the position adjusting bushings are inserted into the rotational shaft.

### BRIEF DESCRIPTION OF THE DRAWINGS

The above and other objects and features of the present invention will become apparent from the following description of preferred embodiments given in conjunction with the accompanying drawings, in which:

FIG. 1 illustrates a sectional view of main parts of a conventional motor;

FIGS. 2A and 2B illustrate a sectional view of main parts of a motor with a position-adjustable rotor in accordance with an embodiment of the present invention; and

FIG. 3 is a sectional view of the motor with a position-adjusted rotor illustrated in FIGS. 2A and 2B; and

FIG. 4 is a diagram for illustrating the working of the motor with the position-adjustable rotor in accordance with the embodiment of the present invention.

### DETAILED DESCRIPTION OF THE PREFERRED EMBODIMENTS

Hereinafter, preferred embodiments of the present invention will be described in detail with reference to the accompanying drawings so that they can be readily implemented by those skilled in the art.

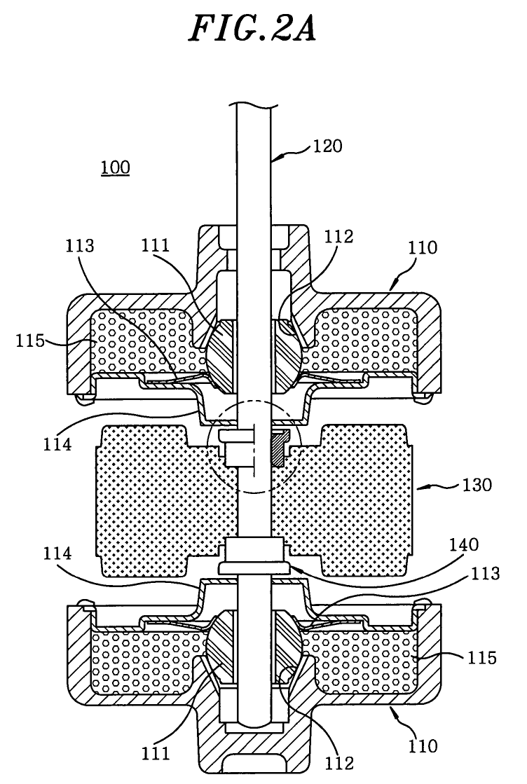

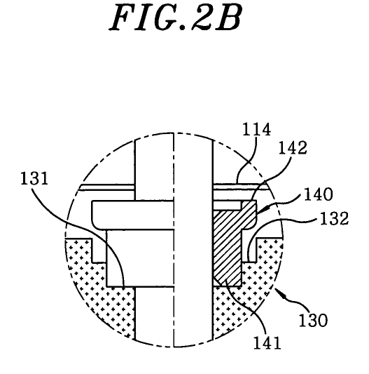

FIGS. 2A and 2B illustrate a sectional view of main parts of a motor 100 with a position-adjustable rotor in accordance with an embodiment of the present invention. The motor 100 with the position-adjustable rotor includes holder assemblies 110, a rotational shaft 120, a rotor 130, position adjusting indentations 131, and position adjusting bushings 140. The rotational shaft 120 is supported to be rotatable by the holder assemblies 110. The rotational shaft 120 is affixed to a central region of the rotor 130, and is formed by pressing soft magnetic powder to form the position adjusting indentations 131. Each of the position adjusting bushings 140 changes a direction of an insertion into the rotational shaft 120 so as to be supported at the interior or exterior side of each of the position adjusting indentations 131. Through this support, the position adjusting bushings 140 can adjust gaps between the rotor 130 and each of the holder assemblies 110.

The holder assemblies 110 include respective bearing installation units 112 in a central region to install oilless bearings 111, which supply lubricating oil to the rotational shaft 120, on the respective bearing installation units 112. Plate springs 113 are installed individually on one portion of each of the oilless bearings 111 exposed by the respective bearing installation units 112. As a result, the plate springs 113 electrically support the respective oilless bearings 111. Bearing covers 114 attached individually to an exterior portion of each of the bearing installation units 112 firmly fix the respective plate springs 113.

Each of the holder assemblies 110 includes a space that a permawick 115 containing oil fills around each of the oilless bearings 111 so as to provide the oil to those regions where friction occurs, e.g., a contact region between the rotational shaft 120 and the corresponding oil bearing 111.

The rotational shaft 120 is affixed to the central region of the rotor 130, and thus rotates with the rotor 130.

The rotor 130 is placed inside a stator (not shown), which is affixed to the inner surface of the casing (not shown), by having a gap inside the stator (not shown), and rotates due to an electron induction event generated by the stator (not shown). The position adjusting indentations 131 are formed around the rotational shaft 120.

The rotor 130 is molded by pressing soft magnetic powder. The soft magnetic powder includes iron-based particles, each coated with a certain material to be electrically insulated from each other.

In detail of the formation of the position adjusting indentations 131, a press molding apparatus includes a molding space formed in a shape substantially the same as the rotor 130, and the soft magnetic powder is filled into the molding space. A pressing member such as a punch presses the soft magnetic powder to form the position adjusting indentations 131 in the rotor 130. A lubricant and/or a binder may be added to the soft magnetic powder and pressed together.

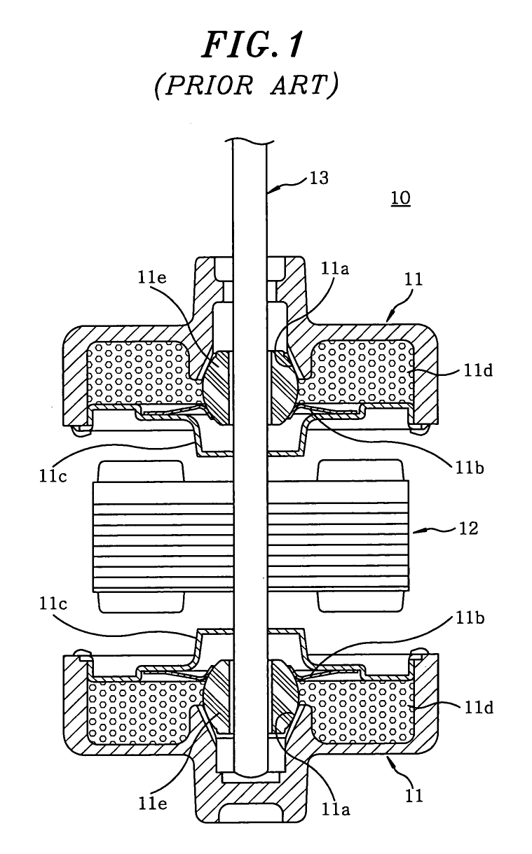

The rotor 130 includes a three-dimensional soft magnetic composite (SMC) by pressing the soft magnetic powder, and usually has a higher degree of freedom as compared with the conventional rotor 12 (see FIG. 1) obtained by stacking identically shaped silicon steel sheets over each other. As a result of this high degree of structural freedom, different from the conventional stack structure of the rotor 12, the position adjusting indentations 131 can be formed in the rotor 130.

The position adjusting bushings 140 are inserted into the rotational shaft 120 to be positioned between the rotor 130 and each of the holder assemblies 110. Each of the position adjusting bushings 140 is formed to have different diameters and widths on both sides, so that gaps between the rotor 130 and each of the holder assemblies 110 can be adjusted by changing the direction that the position adjusting bushings 140 are inserted into the rotational shaft 120. That is, one portion of each of the position adjusting bushings 140 is formed to have a smaller diameter or width than each of the position adjusting indentations 131, and as a result, insertion units 141 that can be supported by being inserted into each of the position adjusting indentations 131 are formed. Also, another portion of each of the position adjusting bushings 140 is formed to have a larger diameter or width than each of the position adjusting indentations 131, and as a result, locking units 142 that can be supported at the exterior side of each of the position adjusting indentations 131 are formed. Therefore, the position adjusting bushings 140 adjust gaps between the rotor 130 and each of the holder assemblies.

At the entrance side of each of the position adjusting indentations 131, the rotor 130 includes locking unit installation openings 132 into which the respective locking units 142 of the position adjusting bushings 140 are inserted and locked.

The locking unit installation openings 132 allow the respective locking units 142 to be inserted into the inside of the respective position adjusting indentations 131, so that the locking unit installation openings 132 can be installed on and locked into the given positions of the rotor 130. As a result, reliability in the rotation of the rotor 130 can be improved. Also, since the locking units 142 need to be locked into the outside of the respective position adjusting indentations 131, each of the locking units 142 has a larger diameter and width than each of the position adjusting indentations 131, and is shallower than each of the position adjusting indentations 131.

The above described motor with the position-adjustable rotor operates as follows.

Referring to FIGS. 2A and 2B, the position adjusting bushings 140 are inserted into the rotational shaft 120, but the insertion units 141 are made to be inserted into the respective position adjusting indentations 131 of the rotor 130 so as to minimize gaps between the rotor 130 and each of the holder assemblies, i.e., the bearing covers 114.

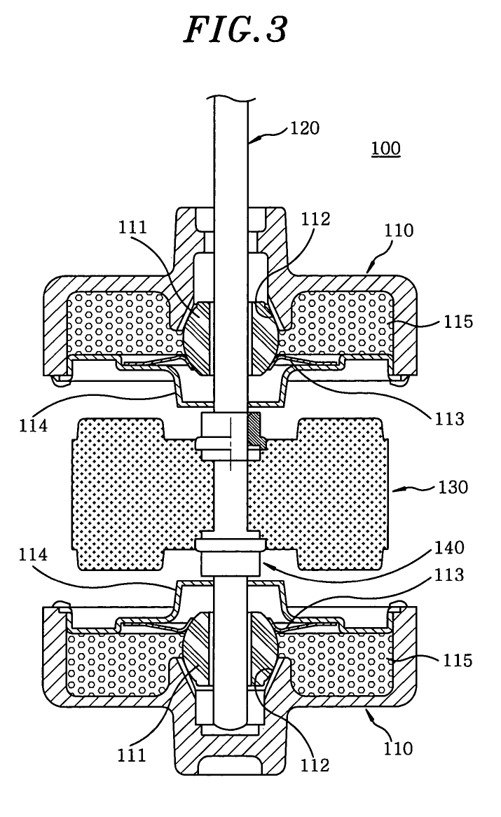

Referring to FIG. 3, when the position of the rotor 130 is changed such that the gaps between the rotor 130 and each of the bearing covers 114 are maximized by changing the specification or structure of the motor 100, the direction that the position adjusting bushings 140 are inserted into the rotational shaft 120 is reversed, so that the locking units 142 are supported individually at the exterior side of each of the position adjusting indentations 131.

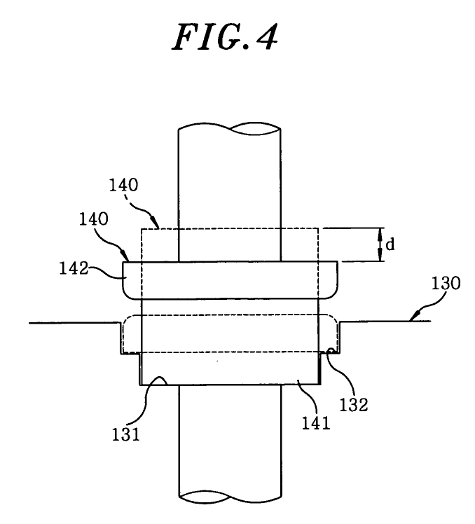

Therefore, as illustrated in FIG. 4, there arises a distance difference “d” between edge portions of the position adjusting bushings 140 that protrude and adjust gaps between the rotor 130 and each of the holder assemblies 110 by changing the direction that the position adjusting bushings 140 are inserted into the rotational shaft 120. As a result, the position of the rotor 130, more particularly, gaps between the rotor 130 and each of the holder assemblies 110 can be adjusted.

It is exemplified in the present embodiment that the position adjusting bushings 140 adjust gaps between the rotor 130 and each of the bearing covers 114 of the holder assemblies 110. However, in consideration of the holder assemblies 110 that can be formed in various structures, a gap between the rotor 130 and any member of the holder assemblies 110 facing the rotor 130 can be adjusted.

Meanwhile, when the locking units 142 of the position adjusting bushings 140 are supported by the rotor 130, the locking units 142 are installed on and locked into the respective locking unit installation openings 132 formed at the entrance side of the respective position adjusting indentations 131 so as to guide the firm fixation of the corresponding position adjusting bushings 140 to a target.

According to the motor 100 with the position-adjustable rotor 130 as described above, different from the conventional rotor 130 formed by stacking the identically shaped silicon steel sheets over each other, since the rotor 130 is formed by molding through pressing the soft magnetic powder, the position adjusting indentations 131 and the locking unit installation openings 132 can be formed. Also, gaps between the rotor 130 and each of the holder assemblies 110 can be adjusted by changing the direction that the position adjusting bushings 140 are inserted into the rotational shaft 120, and the gap adjustment can be performed easily. Hence, substantially the same rotor can be implemented to those motors having different specifications or structures, and this wide implementation allows reduction in manufacturing costs.

On the basis of various embodiments of the present invention, the motor with the position-adjustable rotor can adjust gaps between the rotor and each of the holder assemblies. The gap adjustment can be done easily, and thus, even though motors have different specifications or structures, substantially the same motor can be implemented thereto. As a result, the motors can be manufactured at low cost.

While the invention has been shown and described with respect to the preferred embodiments, it will be understood by those skilled in the art that various changes and modifications may be made without departing from the spirit and scope of the invention as defined in the following claims.

What is claimed is:

1. A motor with a position-adjustable rotor, wherein a rotational shaft of the motor is rotatably supported by a holder assembly, the motor comprising:
a rotor of which the rotational shaft is fixed in a central portion, including a position adjusting indentation around the rotational shaft, and formed by pressing soft magnetic powder; and
a position adjusting bushing, inserted into the rotational shaft to be positioned between the rotor and the holder assembly, including an insertion unit inserted into the position adjusting indentation and a locking unit supported at an exterior side of the position adjusting indentation, wherein the insertion unit and the locking unit have different diameters or widths,
wherein a gap between the rotor and the holder assembly is adjusted by changing a direction in which the position adjusting bushing is inserted into the rotational shaft.

2. The motor of claim 1, wherein the rotor includes a locking unit installation opening which the locking unit is inserted into and locked in at the entrance side of the position adjusting indentation.
